(19) United States
(12) Patent Application Publication
(10) Pub. No.: US 2021/0160567 A1
(43) Pub. Date: May 27, 2021

(54) Method of Merging Multiple Targeted Videos During a Break in a Show

(71) Applicant: Osprey Media, LLC, Morristown, VT (US)

(72) Inventor: Joseph Peter Velardo, Montclair, NJ (US)

(73) Assignee: Osprey Media, LLC, Morristown, VT (US)

(21) Appl. No.: 17/100,593

(22) Filed: Nov. 20, 2020

Related U.S. Application Data
(60) Provisional application No. 62/938,686, filed on Nov. 21, 2019.
(60) Provisional application No. 63/071,210, filed on Aug. 27, 2020.

(51) Int. Cl. H04N 21/44; H04N 21/845; H04N 21/234; H04N 21/458

(52) U.S. Cl. CPC H04N 21/44016; H04N 21/845; H04N 21/44008; H04N 21/458; H04N 21/23424

(57) ABSTRACT

A method of providing video content for an end user video player includes providing a first video segment and a second video segment. The first video segment is different from the second video segment. The method also includes on-the-fly and gaplessly stitching together first content derived from the first video segment with second content derived from the second video segment to form a stitched together file. The method further includes transmitting a playable video derived from the stitched together file to the end user video player. The method further includes inserting the playable video derived from the stitched together file into a break in a program running on the end user video player, and playing the playable video on the end user video player.

### FIELD

This patent application generally relates to techniques for producing and using a video. More particularly, it is related to techniques for merging multiple videos in different formats. Even more particularly, it is related to techniques for merging multiple videos in different formats personalized for the viewer.

### BACKGROUND

Videos in different formats have traditionally taken considerable time to merge. Improvement is needed to more rapidly merge videos in different formats, and this improvement is provided in the current patent application.

### SUMMARY

One aspect of the present patent application is a method of providing video content for an end user video player that includes providing a first video segment and a second video segment. The first video segment is different from the second video segment. The method also includes on-the-fly and gaplessly stitching together a first content derived from the first video segment with a second content derived from the second video segment to form a stitched together file. The method further includes transmitting a playable video derived from the stitched together file to the end user video player. The method further includes inserting the playable video derived from the stitched together file into a break in a program running on the end user video player, and playing the playable video on the end user video player.

Another aspect of the present patent application is a method of providing video content for an end user video player that includes providing a first video content that is in a first playable format. The method also includes translating the first video content to a stitchable format. The method further includes providing a second video content in a stitchable format. The method also includes stitching the first video content in the stitchable format to the second video content in the stitchable format to form a stitched together file; The method further includes transmitting a playable file derived from the stitched together file to the end user video player. The method also includes inserting the playable file derived from the stitched together file into a break in a program playing on the end user video player and playing the playable video on the end user video player in which the playable file derived from the stitched together file is gapless.

### BRIEF DESCRIPTION OF THE DRAWINGS

The foregoing and other aspects and advantages of the invention will be apparent from the following detailed description as illustrated in the accompanying drawings, in which:

FIG. 1 shows a flow chart of one aspect of the present patent application in which videos in different formats are each converted to a stitchable format and stitched together in a specified order, have protocol added to provide a playable format and then are transmitted for playing on an end user's video player;

FIG. 2 shows a flow chart of another aspect of the present patent application in which static and dynamic video files are merged;

FIG. 3 is a block diagram showing a primary content server and a 3^{rd} party server in which the primary content server stores and provides static video files, which are the same for all viewers, and the 3^{rd} party server stores and provides dynamic video files, which are personalized to a parameter of the viewer;

FIG. 4 is a block diagram showing a publisher platform and an end user video player in which, in view of a break in regular content, the end user video player requests native content mini-program information from the publisher platform and the publisher platform responds to the information request with a link to a communication and stitching program (CSP), which is shown in more detail in FIG. 5;

FIG. 5 is a block diagram showing connection and operation of a publisher platform, an end user video player, a communication and stitching program, a Primary Content Server, and a 3^{rd} party server, in which the CSP includes a native content mini-program (NCMP) component and a stitching component that respond to a request for native content mini-program information;

FIGS. 6a, 6b are block diagrams illustrating backend processing of the request of FIG. 5, in which the 3^{rd} party content server supplies dynamic content to the primary content server which stitches segments of dynamic content with segments of static content to form a single stitched-together file for on the fly provision of the native content mini-program to the end user video player; and

FIG. 7 is a block diagram showing serving of the stitched-together native content mini-program file of FIGS. 6a, 6b to the end user video player for viewing by the end user, and showing reporting of the results of that viewing with tracking beacons.

### DETAILED DESCRIPTION

The present application provides a way to merge multiple videos, including videos in different formats, and play them, for example, during a break in a show, with no separation, or gap, between the videos. The merged video content to be played during the break in the TV show may include audio and visual information, such as advertisements, news items, or public service announcements. In the method, the videos to be merged and their order of playing are selected by an operator by providing the addresses of the videos to an operating program running in the cloud.

Each of the videos is transcoded to a stitchable format. The stitchable segments of the videos selected by the operator are then stitched-together into a single stitched-together video file that fits in the time of the break in the show. That single stitched-together video file is then translated to a format that can be played on a video player. Then, the video file in the playable format is transmitted and played on the end user's video player.

In one embodiment, the present application provides a way of providing real time or on the fly gapless streaming of multiple segments of content, each that may be from a different source or in a different format. The stitched-together segments fit into a pre-specified allotted time window in another program program running on the end user's video player.

The process is particularly suitable for “Connected TV” (CTV), which is also known as “Over The Top” (OTT) and “Streaming.” CTV/OTT/Streaming delivers TV content using an internet connection as opposed to through a cable or broadcast provider. CTV/OTT/Streaming includes digital content accessed by apps and streamed over mobile devices, desktops, OTT devices, or smart TVs. OTT devices include Roku, Chromecast, Amazon Fire Stick, Hulu, Apple TV, and certain gaming consoles. Other connected TV devices or systems can be used. Smart TVs have a built-in connection to the internet, such as a built-in Roku.

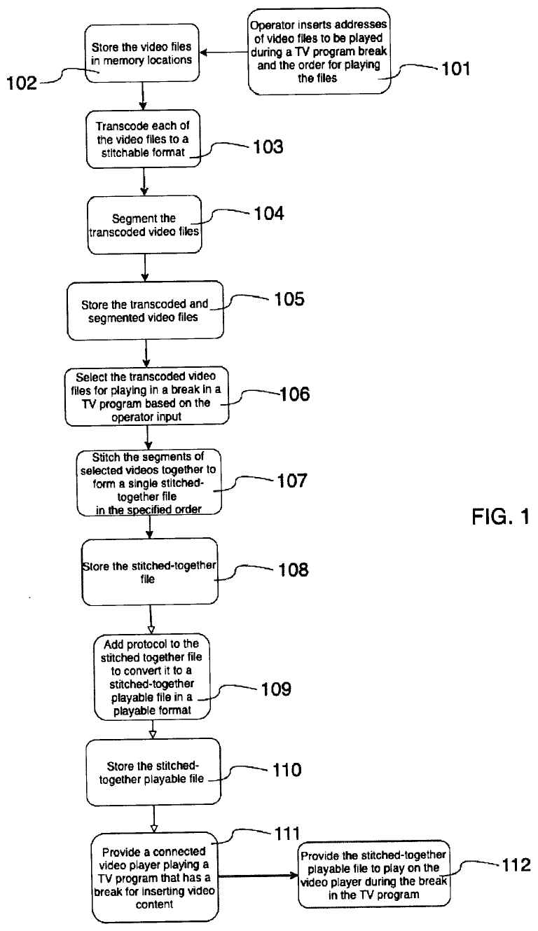

One embodiment of the process is illustrated in the flow chart of FIG. 1. In the process, a program operator provides input to a program running on a server specifying the addresses of each of the video files to be played and the order in which they are to be played, as shown in box 101, during the break in the TV show. The list of video files and the order of playing selected by the end user or operator is stored in a text manifest. The program operator may also specify parameters such as the length of time of each of the videos and/or the total time for all the videos to be played.

In one example, the program operator may input to the program the addresses of five videos to be played in a specified order with a total time for all the videos of 60 seconds. In this example, two of the videos each have a length of 15 seconds while each of the other three videos has a length of 10 seconds to fit into a 60 second break in a TV show.

The videos may be in different formats, such as mp4, mov, WebM, mkv, or any other static file format for storing video and audio. The videos may be in different protocols, such as Video Ad Serving Template (VAST), Video Player Ad Interface (VPAID), Video Multiple Ad Play List (VMAP), or any other protocol for video that may be played on a video player.

The protocol can be used by the end user video player as part of enabling the native content mini-program of the present patent application to play on the end user player. Native content is video content that matches the look and feel of the environment in which it runs. A protocol like VPAID can be used by the presenting server to track how a viewer is interacting with the native content mini-program.

Noteworthy is that in the prior art, for video files all embedded in a video ad serving template protocol, a prior art content server could play one video after another but a time delay separation, or gap, between each of the videos was inevitable.

The present patent application eliminates that delay between videos, providing gapless play of different videos, with no time delay or gap, there between.

The selected video files are copied from their individual addresses and stored, as shown in box 102, transcoded to a stitchable format, as shown in box 103, divided into segments, as shown in box 104, and stored in segments, as shown in box 105.

A stitchable format that may be used is HTTP Live Streaming, also known as HLS, an HTTP-based adaptive bitrate streaming communications protocol developed by Apple Inc. The file name extension for HLS is .m3u8, and HLS files are also known as .m3u8 files.

In the next step, based on the text manifest that includes the list of video files and the order of playing selected by the end user or operator in box 101, the program stitches the transcoded segments of the selected video files together to form a single stitched-together file containing all the specified videos in the specified order, as shown in box 107, stores that single stitched together file in a stitched-together-file memory location having a stitched-together-file address, as shown in box 108, adds protocol to the stitched together file to convert it to a playable format, as shown in box 109, and stored, as shown in box 110. The process of the present patent application allows the stitched together file to include no gap between any of the stitched together segments. An end user's connected video player is provided, as shown in box 111 and the single stitched-together file containing all the specified videos in the specified order is transmitted for playing on the end user's video player in a program break, as shown in box 112. Thus, the transmitted video includes no gap between stitched together elements.

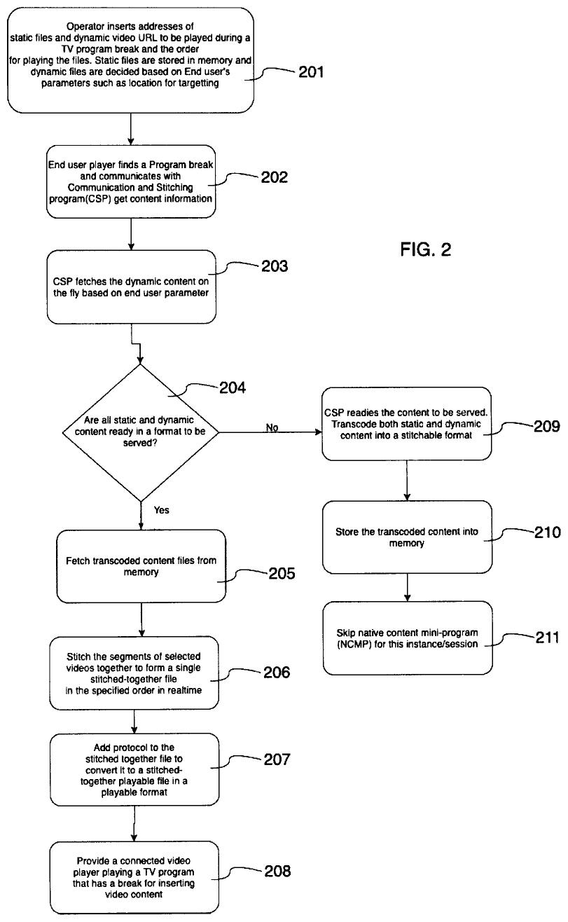

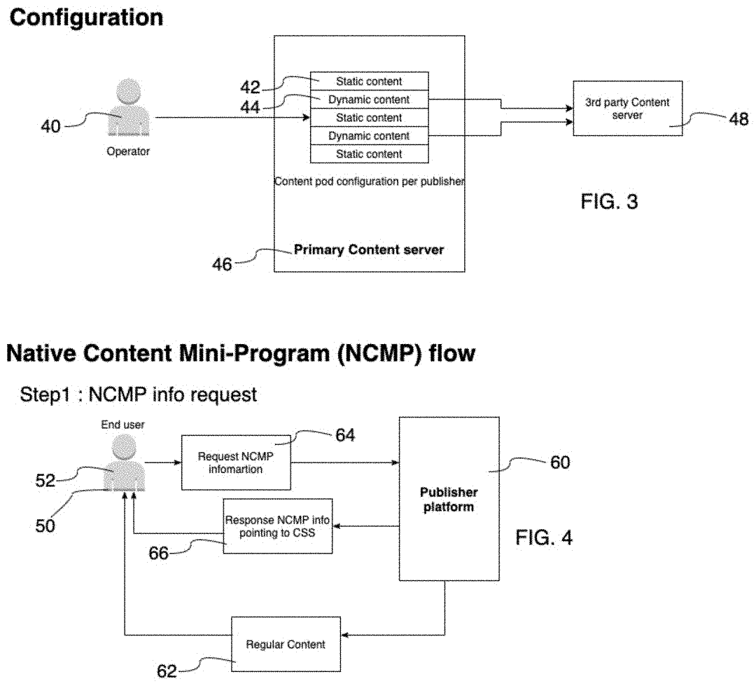

In another embodiment, an operator 40 is responsible to store addresses of static video files 42 and a URL of dynamic video files 44 to be played during a TV program break in primary content server 46 in an order for playing the files, as shown in box 201 in FIG. 2 and in the block diagram of FIG. 3. In one embodiment, static video files 42 are the same for all viewers and the dynamic video files will vary, personalized to a parameter of the viewer. The configuration for the files may be according to specific instructions.

In this embodiment static video files 42 were previously stored in memory in primary content server 46 and the same static video files may be used with all choices of dynamic video files 44. Dynamic video files 44 are stored in 3^{rd} party content servers 48. The decision as to which dynamic video files 44 to use will be based on one or more specific end user targeting parameters 50. End user targeting parameters 50 are stored in end user video player 52, which is playing a TV program that has a break for inserting video content. End user targeting parameters 50 may include end user demographic information, such as age bracket, IP address, location, and screen type. Thus, dynamic video files 44 are targeting for each end user. Dynamic video files 44 may be stored on one or more 3^{rd} party servers 48.

In this embodiment, publisher platform 60, such as Roku, Disney Plus, Quibi, Chromecast, Amazon Fire Stick, Hula, and Apple TV, running on end user video player 52 finds a break in TV program regular content 62 that is playing on end user video player 52. End user video player 52 communicates with publisher platform 60 to request native content mini-program information 64, as shown in box 202 and in FIG. 4.

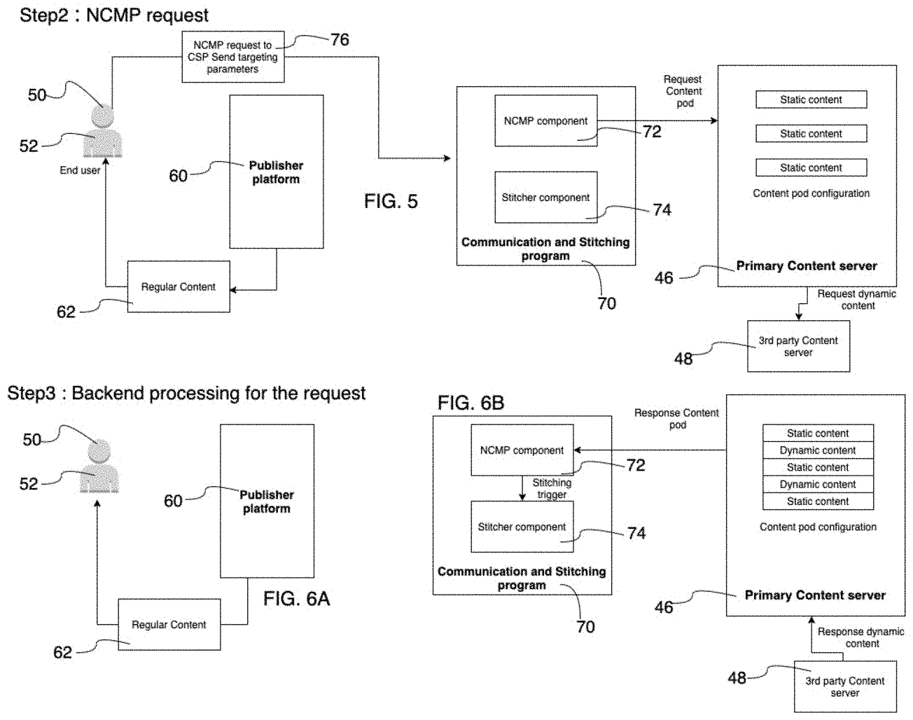

In one embodiment, publisher platform 60 responds to the information request from end user video player 52 by transmitting metadata link 66 to end user video player 52 that connects end user video player 52 to communicating and stitching program (CSP) 70. CSP 70 runs on a processor (not shown) in the cloud, as shown in FIG. 5.

Communicating and stitching program 70 includes native content mini-program component 72 and stitcher component 74, as also shown in FIG. 5. End user video player 52 connects with communicating and stitching program 70 via metadata link 66 and sends native content mini-program request 76 to communicating and stitching program 70. End user video player 52 also sends one or more targeting parameters 50 about the end user.

Native content mini-program component 72 of communicating and stitching program 70 then forwards native content mini-program request 76 to primary native content mini-program server 46 requesting a native content mini-program play list or native content mini-program pod to fill the break in TV program regular content 62 that is playing on end user video player 52. The operator or operator server 40 decides the dynamic content on the fly (in real time), based on end user targeting parameter 50, as shown in box 203. The operator or operator server 40 provides the address of the dynamic video files in 3^{rd} party content server 48 to native content mini-program component 72 of communicating and stitching program 70. Communicating and stitching program 70 then requests dynamic video files 44 from 3^{rd} party content server 48.

As shown in decision diamond 204, communicating and stitching program 70 then determines whether all static and dynamic content are ready in a format to be served?

If yes, communicating and stitching program 70 fetches each of the transcoded native content mini-program segments from its memory, as shown in box 205, and native content mini-program component 72 of communicating and stitching program 70 stitches the segments of these selected videos together to form a single stitched-together file in the specified order in real time (on the fly), as shown in box 206 and in FIGS. 6a, 6b. Thus, the stitching is done without introducing latency or delay.

In the next step, communicating and stitching program 70 adds end user video player protocol to the stitched together file to convert it to a stitched-together-playable file in a playable format, as shown in box 207, and the stitched-together-playable file in a playable format is transmitted to connected end user video player 52, as shown in box 208.

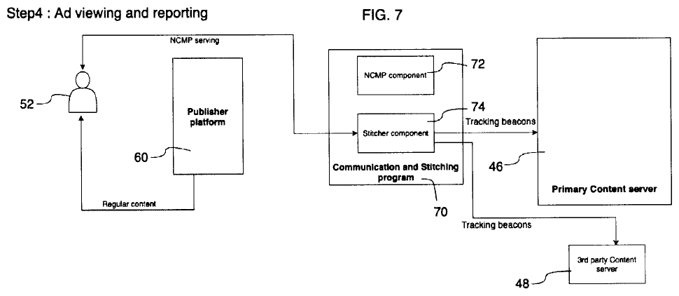

If the answer to decision diamond 204 is no, communicating and stitching program 70 readies the content to be served by transcoding both static and dynamic content into a stitchable format, as shown in box 209, and storing the transcoded content into memory, as shown in box 210 and in FIG. 7. Alternatively, static content may have previously been transcoded to a stitchable format or it may have been recorded in a stitchable format. In view of the delay to transcode into stichable format, insertion into the program running on end user video player 52 may be skipped for this break instance, as shown in box 211, and will be ready to be fetched in box 205 for insertion in the next break in regular content playing on end user video player 52.

In addition, communicating and stitching program 70 tracks end user video player 80 and provides tracking beacons 80 that indicate the percent of ads watched v. turned off and reports the percent that watched dynamic video 44 to 3^{rd} party server 48 and the percent that watched static video 42 to primary content server 46.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

What is claimed is:

1. A method of providing video content for an end user video player, comprising:
a. providing a first video segment and a second video segment;
b. on-the-fly and gaplessly stitching together a first content derived from said first video segment with a second content derived from said second video segment to form a stitched together file;
c. transmitting a playable video derived from said stitched together file to the end user video player; and
d. inserting said playable video derived from said stitched together file into a break in a program running on the end user video player, and playing said playable video on the end user video player.

2. The method as recited in claim 1, further comprising the end user video player transmitting a parameter personalized to the viewer and requesting that said first video segment be related to said parameter.

3. The method as recited in claim 2, further comprising selecting said first segment based on said parameter personalized to the viewer.

4. The method as recited in claim 3, further comprising selecting said first segment from a 3^{rd} party content server based on said parameter personalized to the viewer.

5. The method as recited in claim 3, further comprising tracking action by the viewer in response to the end user video player playing said playable video derived from said stitched together file with said first segment based on said parameter personalized to the viewer.

6. The method as recited in claim 1, further comprising providing said steps (a) to (d) in response to a request from the end user video player.

7. The method as recited in claim 1, wherein said first video segment is from a source different from said second video segment.

8. The method as recited in claim 1, wherein said first video segment is in a format different from said second video segment.

9. The method as recited in claim 1, further comprising deriving said first content by translating said first video segment to a stitchable format.

10. A method of providing video content for an end user video player, comprising:
a. providing a first video content, wherein said first video content is in a first playable format;
b. translating said first video content to a stitchable format;
c. providing a second video content in a stitchable format;
d. stitching said first video content in said stitchable format to said second video content in said stitchable format to form a stitched together file;
e. transmitting a playable file derived from said stitched together file to the end user video player; and
f. inserting said playable file derived from said stitched together file into a break in a program playing on the end user video player and playing said playable video on the end user video player.

11. The method as recited in claim 10, further comprising performing said steps (a) to (f) on the fly in response to a request from the end user video player.

12. The method as recited in claim 10, further comprising translating said stitched together file to a format playable on the end user video player.

13. The method as recited in claim 10, wherein said providing a second video content in a stitchable format includes providing said second video content in a second playable format and translating said second video content to a stitchable format.

14. The method as recited in claim 10, further comprising providing a third video content, wherein said stitching step (d) includes stitching said first video content in said stitchable format to said second video content in said stitchable format and to said third video content in said stitchable format to form said stitched together file.

15. The method as recited in claim 10, further comprising the end user video player transmitting a parameter personalized to the viewer and requesting that said first video segment be related to said parameter.

16. The method as recited in claim 15, further comprising selecting said first segment based on said parameter personalized to the viewer.

17. The method as recited in claim 16, further comprising selecting said first segment from a 3^{rd} party content server based on said parameter personalized to the viewer.

18. The method as recited in claim 10, further comprising tracking action by the viewer in response to the end user video player playing said playable video derived from said stitched together file with said first segment based on said parameter personalized to the viewer.

19. The method as recited in claim 10, wherein said playable file derived from said stitched together file is gapless.
